(19) United States
(12) Patent Application Publication
(10) Pub. No.: US 2024/0392114 A1
(43) Pub. Date: Nov. 28, 2024

(54) TIRE SIDEWALL COMPOSITION AND TIRE SIDEWALL

(71) Applicant: The Goodyear Tire & Rubber Company, Akron, OH (US)

(72) Inventor: Paul Harry Sandstrom, Cuyahoa Falls, OH (US)

(21) Appl. No.: 18/321,839

(22) Filed: May 23, 2023

(51) Int. Cl. C08L 9/00; B60C 1/00; C08K 3/011; C08K 3/04; C08K 3/06; C08K 3/36

(52) U.S. Cl. CPC C08L 9/00; B60C 1/0025; C08K 3/011; C08K 3/04; C08K 3/06; C08K 3/36; C08K 2201/014

(57) ABSTRACT

A tire sidewall rubber composition comprises, based on parts by weight per 100 parts by weight rubber (phr): (A) a blend of polymers comprising at least a polyisoprene and polybutadiene; (B) a reinforcing filler; and (C) a cure package comprising sulfur and at least three accelerators including diphenyl guanidine and tetra benzyl thiuram disulfide and a sulfenamide.

### BACKGROUND

High levels of wax are typically used in sidewall compounds to protect against static ozone weather cracking. 6PPD is typically used in sidewalls for dynamic ozone resistance. Moreover, tire sidewall compounds are dynamically flexed through millions of cycles in their expected lifetimes. Cut growth properties should remain excellent during these lifetimes. A blend of natural rubber and polybutadiene is also used in combination with wax and 6PPD to generate desirable cut growth properties.

The use of high levels of wax contributes to visible bloom on the tire surface which can be objectionable to consumers. A tire sidewall composition is desired from which wax levels are reduced and/or eliminated without compromising the durability of the tire sidewall.

### BRIEF DESCRIPTION

Disclosed, in some embodiments, is a tire having a visible sidewall that contains a rubber composition, based on parts by weight per 100 parts by weight rubber (phr): (A) a blend of polymers comprising at least a polyisoprene and polybutadiene; (B) a reinforcing filler; and (C) a cure package comprising sulfur and at least three accelerators including diphenyl guanidine and tetra benzyl thiuram disulfide and a sulfenamide.

The amount of tetra benzyl thiuram disulfide in the rubber composition may be about 0.25 to about 2.5 phr, preferably about 0.5 to about 1.5 phr.

In some embodiments, the polyisoprene includes natural rubber or synthetic polyisoprene.

Particular embodiments include from about 30 phr to about 60 phr of natural rubber or synthetic polyisoprene and from about 40 phr to about 70 phr of cis 1,4-polybutadiene rubber.

In some embodiments, the reinforcing filler contains carbon black, optionally in combination with silica.

The tire may further include rosin acid. In some embodiments, the amount of rosin acid is from about 0.25 to about 3.0 phr, preferably from about 0.5 to about 2.0 phr.

In some embodiments, the amount of diphenyl guanidine may be from about 0.25 phr to about 3.0 phr.

In some embodiments, the amount of sulfenamide is from about 0.25 phr to about 3.0 phr, preferably from about 0.5 phr to about 2.0 phr.

In some embodiments, the amount of filler may be from about 30 phr to about 70 phr, preferably from about 35 phr to about 55 phr.

In some embodiments, the rubber composition includes at least a 25% reduction in wax relative to a compound devoid of rosin acid, diphenyl guanidine, and tetra benzyl thiuram disulfide.

In some embodiments, the rubber composition may be partially or fully devoid of wax relative to a compound devoid of rosin acid and not containing the disclosed cure package.

In some embodiments, the rubber composition has at least a 25% reduction in 6PPD relative to a compound devoid of rosin acid and not containing the disclosed cure package.

### BRIEF DESCRIPTION OF THE DRAWINGS

The following is a brief description of the drawings, which are presented for the purposes of illustrating the exemplary embodiments disclosed herein and not for the purposes of limiting the same.

FIG. 1 is a partial side view of a non-limiting example of a tire in accordance with some embodiments of the present disclosure.

FIG. 2 is a flow chart illustrating a non-limiting example of an article formation process in accordance with some embodiments of the present disclosure.

### DETAILED DESCRIPTION

The present disclosure may be understood more readily by reference to the following detailed description of desired embodiments included therein and the drawings. In the following specification and the claims which follow, reference will be made to a number of terms which shall be defined to have the following meanings.

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent can be used in practice or testing of the present disclosure. All publications, patent applications, patents, and other references mentioned herein are incorporated by reference in their entirety. The materials, methods, and articles disclosed herein are illustrative only and not intended to be limiting.

The singular forms “a,” “an,” and “the” include plural referents unless the context clearly dictates otherwise.

As used in the specification and in the claims, the term “comprising” may include the embodiments “consisting of” and “consisting essentially of.” The terms “comprise(s),” “include(s),” “having,” “has,” “can,” “contain(s),” and variants thereof, as used herein, are intended to be open-ended transitional phrases that require the presence of the named ingredients/steps and permit the presence of other ingredients/steps. However, such description should be construed as also describing compositions, mixtures, or processes as “consisting of” and “consisting essentially of” the enumerated ingredients/steps, which allows the presence of only the named ingredients/steps, along with any impurities that might result therefrom, and excludes other ingredients/steps.

Unless indicated to the contrary, the numerical values in the specification should be understood to include numerical values which are the same when reduced to the same number of significant figures and numerical values which differ from the stated value by less than the experimental error of the conventional measurement technique of the type used to determine the particular value.

All ranges disclosed herein are inclusive of the recited endpoint and independently combinable (for example, the range of “from 2 to 10” is inclusive of the endpoints, 2 and 10, and all the intermediate values). The endpoints of the ranges and any values disclosed herein are not limited to the precise range or value; they are sufficiently imprecise to include values approximating these ranges and/or values.

As used herein, approximating language may be applied to modify any quantitative representation that may vary without resulting in a change in the basic function to which it is related. Accordingly, a value modified by a term or terms, such as “about” and “substantially,” may not be limited to the precise value specified, in some cases. The modifier “about” should also be considered as disclosing the range defined by the absolute values of the two endpoints. For example, the expression “from about 2 to about 4” also discloses the range “from 2 to 4.” The term “about” may refer to plus or minus 10% of the indicated number. For example, “about 10%” may indicate a range of 9% to 11%, and “about 1” may mean from 0.9-1.1.

For the recitation of numeric ranges herein, each intervening number there between with the same degree of precision is explicitly contemplated. For example, for the range of 6-9, the numbers 7 and 8 are contemplated in addition to 6 and 9, and for the range 6.0-7.0, the number 6.0, 6.1, 6.2, 6.3, 6.4, 6.5, 6.6, 6.7, 6.8, 6.9, and 7.0 are explicitly contemplated.

The term “phr” as used herein, and according to conventional practice, refers to “parts of a respective material per 100 parts by weight of rubber.” The terms “rubber” and “elastomer” can be used interchangeably, unless otherwise indicated. The terms “rubber composition,” “compounded rubber,” and “rubber compound” can be used interchangeably to refer to “rubber which has been blended or mixed with various ingredients and materials” and the terms “cure” and “vulcanize” may also be used interchangeably herein, unless otherwise indicated and such terms are well known to those having skill in the rubber mixing or rubber compounding art.

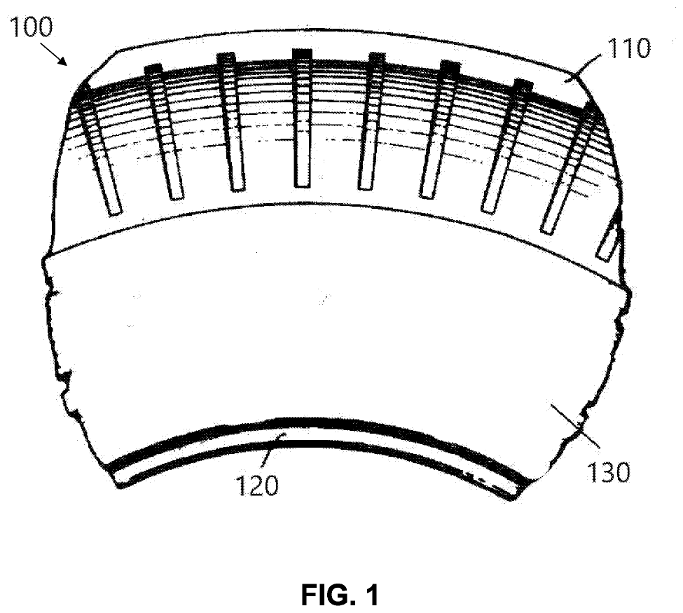

FIG. 1 is a partial side view of a non-limiting example of a tire 100 in accordance with some embodiments of the present disclosure. The tire 100 includes a tread portion 110, a bead portion 120, and a sidewall portion 130 located between the tread portion 110 and the bead portion 120. The tread portion 110, bead portion 120, and sidewall portion 130 of tires in accordance with the present disclosure are not limited to the particular configuration depicted in FIG. 1. For example, there may be multiple sidewall portions, ribs, patterns, colors, etc. FIG. 1 is provided to illustrate one example of where the tire sidewall composition of the present disclosure may be utilized.

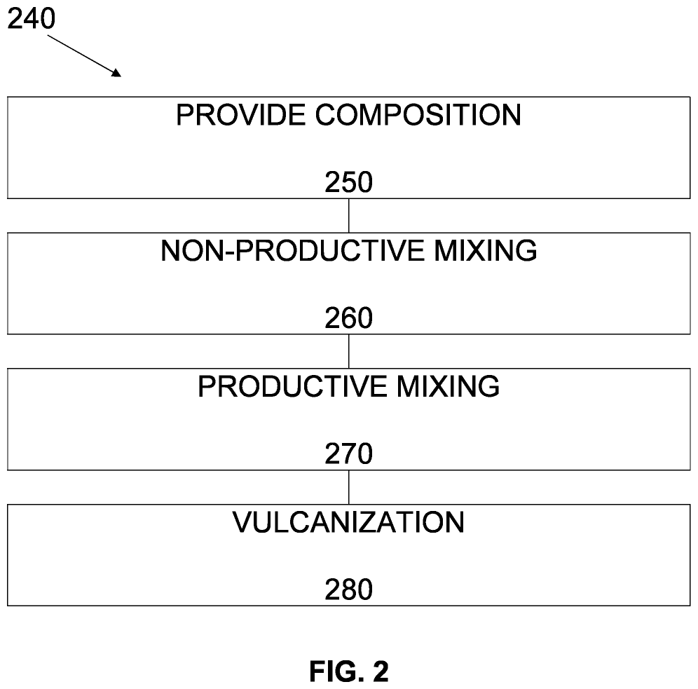

FIG. 2 is a flow chart illustrating a non-limiting example of a process 240 of forming an article (e.g., a tire) in accordance with some embodiments of the present disclosure. The process 240 includes providing a tire sidewall composition 250, non-productive mixing 260, productive mixing 270, and vulcanization 280.

The disclosed invention unexpectedly allows for a reduction in wax level (e.g., a reduction of at least 25% from a typical wax level in a sidewall of up to 4 phr) and reduces or eliminates visible wax bloom in the vulcanized product. The inclusion of the disclosed cure package with rosin acid unexpectedly leads to a significant improvement in cut growth performance.

In one embodiment, the rosin acid may be mixed in the non-productive mixing stage 260 and the cure package may be mixed in the productive stage 270. The sulfur and accelerator(s) may be mixed with the non-productive mixture from stage 260 in productive mixing stage 270 prior to vulcanization 280.

### Rosin Acid

The rosin acid may be included in the composition in an amount of about 0.25 phr to about 3.0 phr. In some embodiments, the rosin acid content is about 0.5 phr to about 2.0 phr.

### Diphenyl Guanidine

The diphenyl guanidine may be included in the composition in an amount of about 0.25 phr to about 3.0 phr. In some embodiments, the diphenyl guanidine content is about 0.5 phr to about 2.5 phr.

### Tetra Benzyl Thiuram Disulfide

The tetra benzyl thiuram disulfide may be included in the composition in an amount of about 0.25 phr to about 2.5 phr. In some embodiments, the tetra benzyl thiuram disulfide content is about 0.5 phr to about 1.5 phr.

The composition provided to the non-productive mixing stage further contains at least one elastomer (e.g., at least one diene elastomer) and a reinforcement filler.

### Elastomers

In some embodiments, the elastomer(s) are selected from natural rubber, synthetic polyisoprene, and/or polybutadiene.

In particular embodiments, the at least one diene elastomer includes from about 30 phr to about 60 phr of natural rubber or synthetic polyisoprene and from about 40 phr to about 70 phr of cis 1,4-polybutadiene.

### Polybutadiene

In some embodiments, the polybutadiene is a cis 1,4-polybutadiene. However, in other embodiments, the polybutadiene is a lithium-produced polybutadiene. The lithium-produced polybutadiene may have a trans content of about 45 to 55%, a cis content of about 35 to 45%, and a vinyl content of about 7.5 to 12.5%.

The cis 1,4-polybutadiene may be included in the composition in an amount of about 10 to about 60 phr. In some embodiments, the cis 1,4-polybutadiene content is about 20 to about 50 phr, including about 30 to about 40 phr or about 35 phr.

In some embodiments, the cis 1,4 content of the cis 1,4-polybutadiene may be at least 95%, at least 96%, at least 97%, or at least 98%.

Non-limiting examples of suitable cis 1,4-polybutadienes include BUDENE® 1207, BUDENE® 1208, BUDENE® 1208G, BUDENE® 1208W, BUDENE® 1280, BUDENE® 1222, BUDENE® 1223, and BUDENE® 1224, all of which are available from The Goodyear Tire and Rubber Company.

The lithium-produced polybutadiene generally has a higher trans than cis content. The lithium-produced polybutadiene may have a glass transition temperature (T_{g}) in a range of about −92 to about −88° C.

### Cis 1,4-Polyisoprene

The cis 1,4-polyisoprene rubber may be natural or synthetic rubber. In some preferred embodiments, the cis 1,4-polyisoprene is a natural rubber.

The cis 1,4-polyisoprene may be included in the composition in an amount of about 40 to about 70 phr.

Non-limiting examples of natural rubber grades include TSR10 and TSR20.

### Filler

The filler may be included in an amount of from about 30 phr to about 70 phr, preferably from about 35 phr to about 55 phr.

Non-limiting representative examples of rubber reinforcing carbon blacks are referenced in The Vanderbilt Rubber Handbook, 13th edition, year 1990, on Pages 417 and 418 with their ASTM designations. This document is incorporated by reference herein. As indicated, such rubber reinforcing carbon blacks may have iodine absorptions (measure of particle size) ranging from, for example, 60 to 240 g/kg and DBP (dibutyl phthalate; measurement of structure) values ranging from 34 to 150 cc/100 g. One non-limiting example of a suitable carbon black is ASTM N326 which has an approximate DBP value of 72 and an approximate Iodine number of 82.

The reinforcing filler typically includes carbon black and optionally silica (e.g., synthetic precipitated silica). A total amount of filler may be in the range of about 30 phr to about 70 phr, preferably from about 35 phr to about 55 phr. The disclosure contemplates that carbon black would make up the majority filler content when carbon black and silica are used in combination.

The precipitated silica reinforcement may, for example, be characterized by having a BET surface area, as measured using nitrogen gas, in the range of, for example, about 40 to about 600, and more usually in a range of about 50 to about 300 square meters per gram. The BET method of measuring surface area might be described, for example, in the Journal of the American Chemical Society, Volume 60, as well as ASTM D3037.

Various commercially available precipitated silicas may be used, such as for example, and not intended to be limiting, silicas from PPG Industries under the Hi-Sil trademark with designations 210, 243, 315, etc.; silicas from Solvay with, for example, designations of Zeosil 1165MP™ and Zeosil 165GR™; silicas from Evonik with, for example, designations VN2 and VN3; and chemically treated (pre-hydrophobated) precipitated silicas such as for example Agilon™ 400 from PPG.

A coupling agent may be included, however in some embodiments the rubber composition does not contain any coupling agent even when carbon black and silica are used as the filler.

The rubber composition optionally may also contain up to about 15, alternatively about 2 to about 15, phr of at least one additional diene-based elastomer selected from at least one of organic solvent solution polymerization prepared, or emulsion polymerization prepared, styrene/butadiene copolymer rubber, isoprene/butadiene copolymer, and styrene/isoprene/butadiene terpolymer. Said additional solvent polymerization prepared elastomer may also be a tin coupled elastomer.

The rubber compositions can be prepared by simple mixing. In some embodiments, the mixing will be carried out utilizing an internal rubber mixer or an open roll (e.g., dual opposing rolls) mill mixer. An internal rubber mixer is preferred, and it is generally preferred to mix the triglyceride oil and filler into the elastomer composition during at least one non-productive compounding stage. With reference to FIG. 2, this may be referred to as a non-productive mixing stage 260.

The rubber compositions of the present disclosure optionally contain one or more additional compounding ingredients and/or additives. Typical amounts of processing aids and rubber compounding ingredients comprise about 1 to about 50 phr. Such processing aids can include, for example, aromatic, naphthenic, paraffinic processing oils, vegetable triglyceride, and plant-derived oils. Stearic acid can be present, although the embodiments contemplate rosin acid as a replacement of stearic acid.

Vulcanization 280 is conducted in the presence of the disclosed cure package.

Accelerators are used to control the time and/or temperature required for vulcanization and to improve the properties of the vulcanizate. Combinations of the disclosed accelerators produce a synergistic effect on the final properties and are better than those produced by use of either accelerator alone. Examples of sulfenamide accelerators include N-oxydiethylene benzothiazole-2-sulfenamide, N-t-butyl-2-benzothiazolesulfenamide and N-cyclohexyl-2-benzothiazolesulfenamide.

The compositions in accordance with the present disclosure exhibit improved appearance while maintaining critical cured properties of ozone resistance, tear, and cut growth.

The following examples are provided to illustrate the devices and methods of the present disclosure. The examples are merely illustrative and are not intended to limit the disclosure to the materials, conditions, or process parameters set forth therein.

### Examples

Examples were produced using a combination of rosin acid and diphenyl guanidine in a tire sidewall compound. A significant reduction in wax level was enabled and tires with no visible wax bloom and a much better looking surface and excellent static ozone protection can be produced.

| Composition, based on | | | |
|---|---|---|---|
| 100 phr elastomer | Control | Exp'l A | Exp'l B |
| Natural Rubber | 65 | 65 | 65 |
| Cis-PPD | 35 | 35 | 35 |
| Carbon Black | 50 | 50 | 50 |
| Processing Oil, A/O, | | | |
| and other additives | In equal parts | | |
| Wax | 3 | 2.2 | 1 |
| Rosin Acid | 0 | 1.5 | 1.5 |
| 6PPD | 4.3 | 4.75 | 4.0 |
| Sulfur | 2.2 | 2.2 | 2.2 |
| Sulfenamide | 0.75 | 0.75 | 0.25-0.75 |
| DPG | 0 | 0.25 | 1.0 |
| TBZD | 0 | 0 | 1.5 |
| Visible Bloom | Reference | Improved | Substantially |
| | | | Improved (No |
| | | | Bloom) |
| Static Ozone | Reference | Improved | Substantially |
| | | | Improved |
| Dynamic Ozone | Reference | Equal | Improved |
| Cut Growth | Reference | Worse | Equal (to Control) |
| Tear Strength | Reference | Equal | Equal |

The invention in Experimental B shows equivalent performance with an improvement in dynamic, ozone, and cut growth.

This written description uses examples to describe the disclosure, including the best mode, and also to enable any person skilled in the art to make and use the disclosure. Other examples that occur to those skilled in the art are intended to be within the scope of the present disclosure if they have structural elements that do not differ from the same concept, or if they include equivalent structural elements with insubstantial differences. It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

We claim:

1. A tire having a visible sidewall, wherein a rubber composition of the sidewall comprises, based on parts by weight per 100 parts by weight rubber (phr):
(A) a blend of polymers comprising at least a polyisoprene and polybutadiene;
(B) a reinforcing filler comprising silica, carbon black, or a combination of both; and
(C) a cure package comprising sulfur; and
at least three accelerators including diphenyl guanidine and tetra benzyl thiuram disulfide and a sulfenamide.

2. The tire of claim 1, wherein an amount of tetra benzyl thiuram disulfide is about 0.25 to about 2.5 phr.

3. The tire of claim 1, wherein an amount of tetra benzyl thiuram disulfide is about 0.5 to about 1.5 phr.

4. The tire of claim 1, wherein the polyisoprene is natural rubber, synthetic polyisoprene, or a combination of the above.

5. The tire of claim 1, further comprising:
from about 30 phr to about 60 phr of natural rubber or synthetic polyisoprene;
and from about 40 phr to about 70 phr of cis 1,4-polybutadiene rubber.

6. The tire of claim 1, wherein the reinforcing filler comprises carbon black.

7. The tire of claim 1, wherein the reinforcing filler comprises a blend of carbon black and silica.

8. The tire of claim 1, further comprising rosin acid.

9. The tire of claim 8, wherein the amount of rosin acid is from about 0.25 phr to about 3.0 phr.

10. The tire of claim 8, wherein the amount of rosin acid is from about 0.5 phr to about 2.0 phr.

11. The tire of claim 1, wherein an amount of the diphenyl guanidine is from about 0.25 phr to about 3.0 phr.

12. The tire of claim 1, wherein an amount of the diphenyl guanidine is from about 0.5 phr to about 2.5 phr.

13. The tire of claim 1, wherein the amount of sulfenamide is from about 0.25 phr to about 2.5 phr.

14. The tire of claim 1, wherein the amount of filler is from about 30 phr to about 70 phr.

15. The tire of claim 1, wherein the rubber composition comprises at least a 25% reduction in wax relative to a compound devoid rosin acid and the cure package.

16. The tire of claim 1, wherein the rubber composition comprises at least a 25% reduction in 6PPD relative to a compound devoid rosin acid and the cure package.

17. The tire of claim 1, wherein the rubber composition is partially or fully devoid of wax.
